(19) United States
(12) Patent Application Publication
(10) Pub. No.: US 2009/0193735 A1
(43) Pub. Date: Aug. 6, 2009

(54) SHEAR LOCK MODULAR BUILDING PANEL ASSEMBLY

(76) Inventor: Ramon Kalinowski, Langley (CA)

Correspondence Address: CAMERON IP, SUITE 1401 - 1166 ALBERNI STREET, VANCOUVER, BC, V6E 3Z3, CA

(21) Appl. No.: 12/023,974

(22) Filed: Jan. 31, 2008

(51) Int. Cl. E04B 2/74; F16B 5/12; E04B 1/35; E04B 1/38

(52) U.S. Cl. 52/281; 52/586.1; 403/359.5; 52/745.21

(57) ABSTRACT

A modular building panel assembly is provided having a first member and a second member. The first member has an inter-engageable marginal portion. The inter-engageable marginal portion of the first member includes inter-engagement means and a pair of spaced apart flanges. The flanges define a channel. The second member has an inter-engageable marginal portion. The inter-engageable marginal portion of the second member includes inter-engagement means. The inter-engageable marginal portion of the second member is receivable between the flanges of the first member. The inter-engagement means of one of said first member or said second member is a plurality of spaced-apart female engagement means. The inter-engagement means of another of said first member or said second member is a plurality of resilient, spaced-apart, male engagement means. Each said male engagement means is positioned to engage a respective one of the female engagement means when the inter-engageable marginal portion of the second member is received between the flanges, thereby inhibiting shear between the first member and the second member when the modular building panel assembly is constructed.

### BACKGROUND OF THE INVENTION

The present invention relates to a modular building panel assembly and, in particular, a system and method for connecting modular building panels.

Conventional modular building panels have elongated male and female engagement means which extend continuously along marginal portions of the panels as disclosed in U.S. Pat. No. 5,247,773 to Weir, U.S. Pat. No. 4,186,539 to Harmon et al., and U.S. Pat. Nos. 4,769,963 and 5,086,599 to Meyer. Such panels, as a result, propose a locking mechanism that provides the building continuity throughout the totality of their respective engagement means. However, this prior art leads to a fundamental problem which is the inability of the engagement means to transfer some naturally occurring forces between panels; therefore, failing to maintain the structural continuity through the inter-engagement means, which may lead to structural failure. It is known to those skilled in the art that “a chain is only as strong as its weakest link”. Further difficulties with conventional modular building panels include the fact that such panels only have limited means to prevent inter-engaged panels from becoming spaced-apart with respect to their marginal portions. They do not have means for inhibiting naturally occurring shear forces acting on the marginal portions of said inter-engaged panels.

There is therefore a need for modular building panels that may be inter-engaged allowing the structural continuity and structural integrity of the engagement means, and that have means for inhibiting shear forces acting on the marginal portions of inter-engaged panels.

### SUMMARY OF THE INVENTION

According to an aspect of the present invention there is provided a modular building panel assembly to be used as a floor, wall, ceiling, roof or any other part of a stationary or mobile structure, the modular building panel comprising a first member and a second member. The first member has an inter-engageable marginal portion. The inter-engageable marginal portion of the first member includes inter-engagement means and a pair of spaced apart flanges. The flanges define a channel. The second member has an inter-engageable marginal portion. The inter-engageable marginal portion of the second member includes inter-engagement means. The inter-engageable marginal portion of the second member is receivable between the flanges of the first member. The inter-engagement means of one of said first member or said second member is a plurality of spaced-apart female engagement means. The inter-engagement means of another of said first member or said second member is a plurality of resilient, spaced-apart, male engagement means. Each said male engagement means is positioned to engage a respective one of the female engagement means when the inter-engageable marginal portion of the second member is received between the flanges, thereby inhibiting pulling-apart as well as shear between the first member and the second member when the modular building panel assembly is constructed.

According to another aspect of the invention, there is provided a method of connecting a first member of a modular building panel assembly to a second member of the modular building panel assembly. The method comprises forming a pair of spaced-apart flanges along an inter-engageable marginal portion of the first member, the flanges defining a channel; forming a plurality of spaced-apart female engagement means along the inter-engageable marginal portion of the first member; forming a plurality of resilient, spaced-apart, male engagement means along an inter-engageable marginal portion of the second member, the male engagement means being spaced-apart along an axis which is generally perpendicular to a longitudinal axis of the marginal portion of the second member; positioning the inter-engageable marginal portion of the second member within the channel; and engaging the male engagement means and female engagement means, thereby inhibiting pulling apart and shear between the first member and the second member.

According to yet another aspect of the invention there is provided a method of connecting a first member of a modular building panel assembly to a second member of the modular building panel assembly. The method comprises forming a pair of spaced-apart flanges along an inter-engageable marginal portion of the first member, the flanges defining a channel; forming a plurality of resilient, spaced-apart, male engagement means along the inter-engageable marginal portion of the first member, the male engagement means being spaced-apart along an axis which is generally perpendicular to a longitudinal axis of the marginal portion of the first member; forming a plurality of spaced-apart female engagement means along an inter-engageable marginal portion of the second member; positioning the inter-engageable marginal portion of the second member within the channel; and engaging the male engagement means and female engagement means, thereby inhibiting shear between the first member and the second member.

### BRIEF DESCRIPTION OF THE DRAWINGS

In the drawings:

FIG. 1 is a front isometric view showing a modular building panel assembly, according to an embodiment of the invention;

FIG. 2 is a front isometric view showing a spline and a modular building panel of the modular building panel assembly of FIG. 1;

FIG. 2A is a front isometric view showing a male and a female modular building panel of the modular building panel assembly of FIG. 1;

FIG. 3 is an exploded top end isometric view showing the spline and the modular building panel of FIG. 2;

FIG. 3A is an exploded top end isometric view showing the male and female modular building panels of FIG. 2A;

FIG. 4 is a top end isometric view showing the spline and the modular building panel of FIG. 2;

FIG. 5 is a top end isometric view showing inter-engagement of the spline and the modular building panel of FIG. 2;

FIG. 6 is a top end isometric view showing the inter-engagement of a spline and two modular building panels of the modular building panel assembly of FIG. 1;

FIG. 6A is a top end isometric view showing the inter-engagement of a corner spline and two modular building panels of the modular building panel assembly of FIG. 1;

FIG. 7 is a fragmentary isometric view showing inter-engagement means of the modular building panel of FIG. 2;

FIG. 8 is a fragmentary isometric view showing inter-engagement means of a modular building panel, according to another embodiment;

FIG. 9 is a fragmentary isometric view showing inter-engagement means of the spline of FIG. 2;

FIG. 10 is fragmentary top view, partially in cross-section, showing the inter-engagement means of FIGS. 7 and 9 prior to inter-engagement of the spline and the modular building panel of FIG. 2;

FIG. 11 is a top sectional view showing the inter-engagement means of FIGS. 7 and 9 when the spline and the modular building panel of FIG. 2 are temporarily inter-engaged; and

FIG. 12 is another top sectional view showing the inter-engagement means of FIGS. 7 and 9 when the spline and the modular building panel of FIG. 2 are permanently inter-engaged.

### DETAILED DESCRIPTION OF THE PREFERRED EMBODIMENT

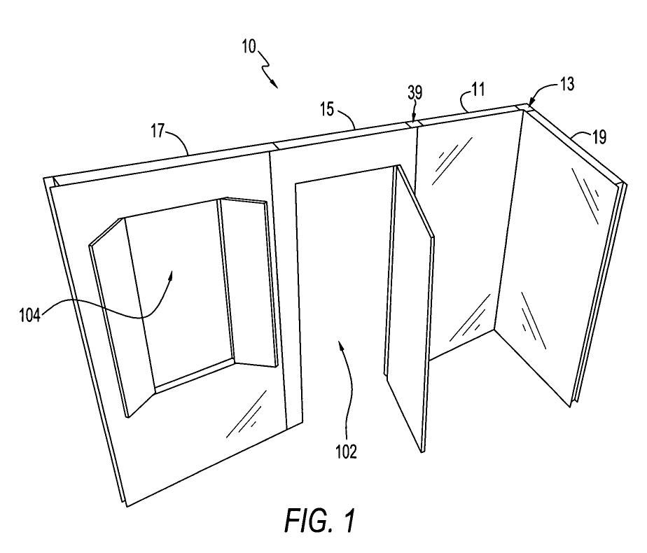

Referring to the drawings and first to FIG. 1, there is shown a modular building panel assembly indicated generally by reference numeral 10. Modular building panel assemblies typically comprise a plurality of modular building panels and form simplified building structures. Four such modular building panels 11, 15, 17, and 19 are shown in FIG. 1. A first pair of the modular building panels 11 and 15 are connected by an inter-panel member in the form of a spline 39 which is inter-engageable with the modular building panels 11 and 15. A second pair of the modular building panels 11 and 19 are connected by an inter-panel member in the form of a corner-spline 13 which is inter-engageable with the modular building panels 11 and 19, and generally maintains building panels 11 and 19 at right angles to each other. A third pair of the modular building panels 15 and 17 are inter-engaged with each other.

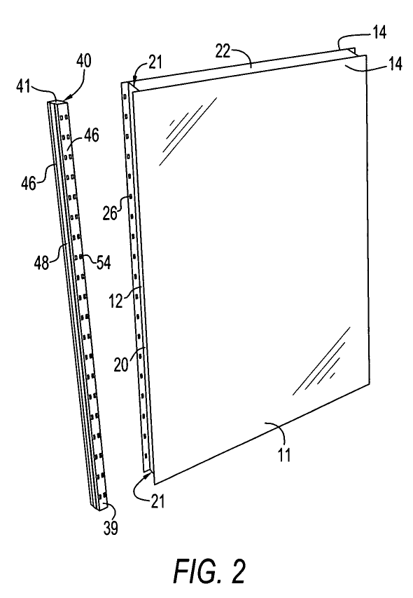

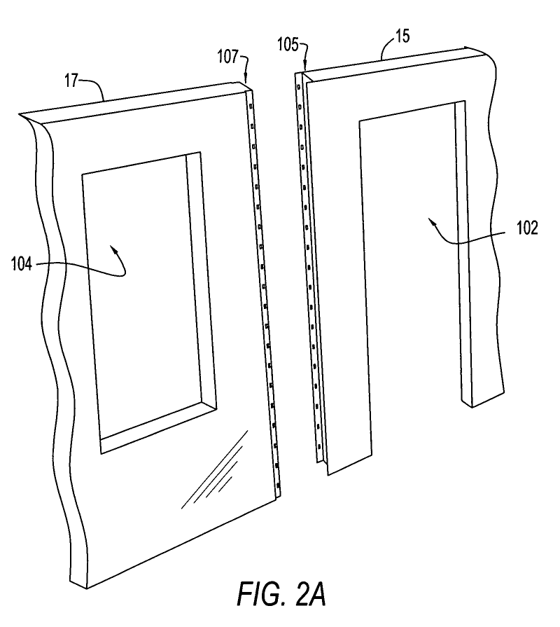

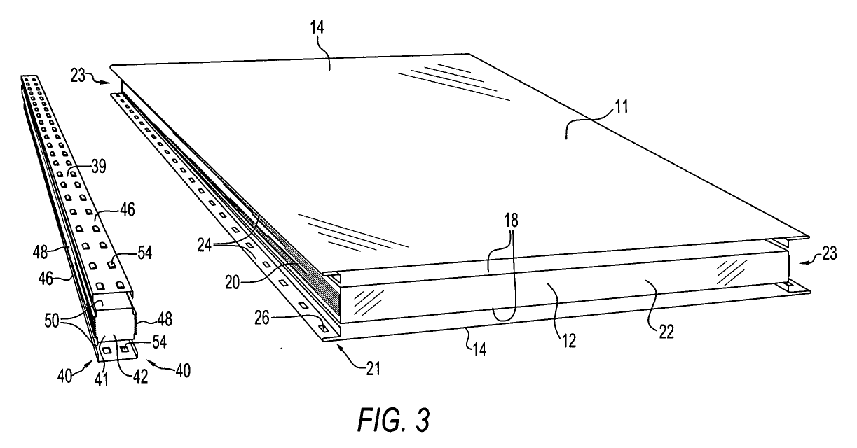

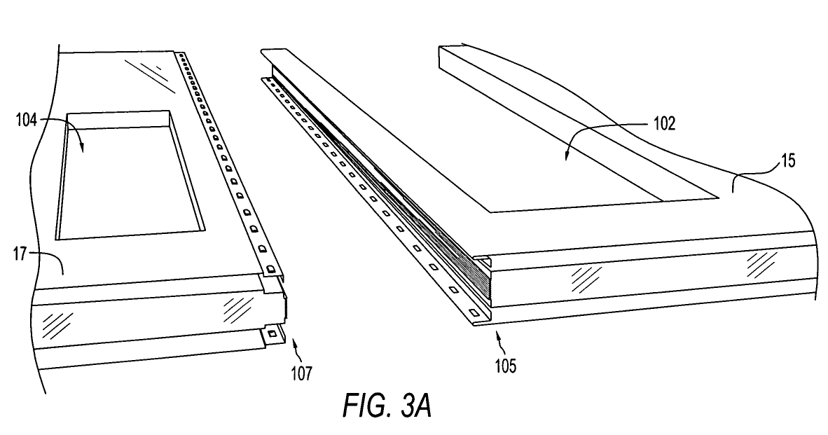

The modular building panels 11, 15, 17, and 19 generally have similar structures with the following notable exceptions. A first one of the modular building panel 17 further includes an opening 104 therethrough in the form of a window opening and has a male inter-engagement means. A second one of the modular building panels 15 further includes an opening 102 therethrough in the form of a doorway. A standard modular building panel 11 is best shown in FIGS. 2 and 3. In this example, the modular building panel 11 has a composite wall structure although this is not required. The modular building panel 11 has a thermal insulating core 12 composed of polystyrene or other core suitable materials. The thermal insulating core 12 has a top end 22, a bottom end (not shown), a pair of opposed side ends 20 of which only one is shown, and a pair of opposed wall surfaces 18 of which only one is shown in FIG. 3. The terms “top”, “bottom”, and “side” are used in relation to positions when the modular building panel 11 is in an upright orientation as shown in FIG. 2 for the construction of the modular building panel assembly 10 shown in FIG. 1.

The modular building panel 11 has a pair of opposed outer skins 14 which are attached to respective ones of the wall surfaces 18 of the insulating core 12 of the modular building panel 11. The skins 14 are in a co-planar relationship with respect to each other. In this example the skins 14 are sheet metal skins; however, other suitable materials may also be used such as carbon fibre, kevlar and other man made-materials. The insulating core 12 and skins 14 are attached using glue in this example; however, other suitable means of attachment may also be used.

As shown in FIG. 3, extending laterally from each of the side ends 20 of the insulating core 12 are a pair of opposed flanges 24. In this example, the flanges 24 are integral with the skins 14 and extend the entire longitudinal length of the side ends 20 of the insulating core 12. The flanges 24 form a U-shaped channel which is indicated generally by reference numeral 23. It will be understood by those skilled in the art that in another embodiment there may be a plurality of spaced-apart flanges along the longitudinal length of the side ends of the insulating core instead of continuous single flanges.

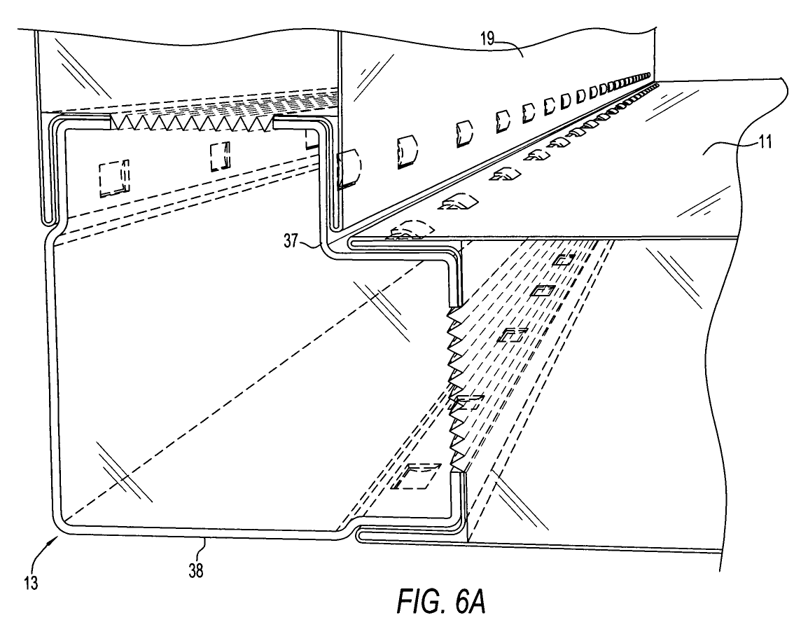

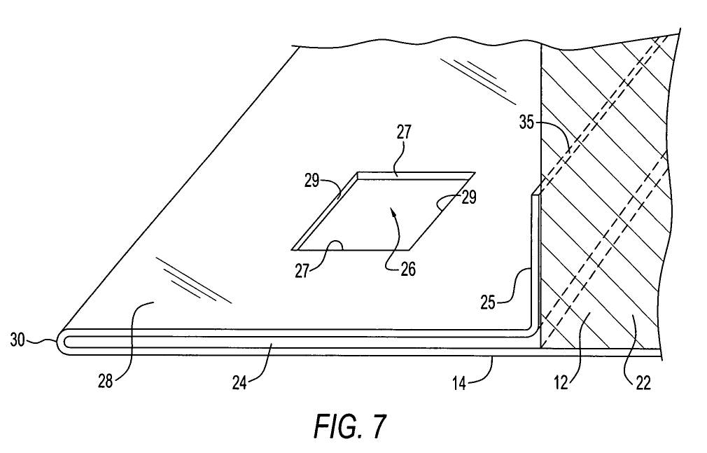

Referring now to FIG. 7, one of the flanges 24 is shown in greater detail. The flange 24 is lapped to form a rounded corner 30 and an inner plate 28 and a return 25. The return 25 of the flange 24 has a terminal edge 35 which, in this example, also corresponds to a terminal edge of the outer skin 14. The flange 24 has inter-engagement means. In this example, the inter-engagement means is a row of female engagement means 26 which are spaced-apart along the longitudinal length of the flange 24. The female engagement means 26 are in the form of rectangular openings cut through the inner plate 28 of the flange 24. Each female engagement means 26 has a pair of opposed transverse edges 27 and pair of opposed longitudinal edges 29. The transverse edges 27 and the longitudinal edges 29 define the rectangular opening that is the female engagement means 26. Although in this example the openings are rectangular they may be other shapes in other embodiments.

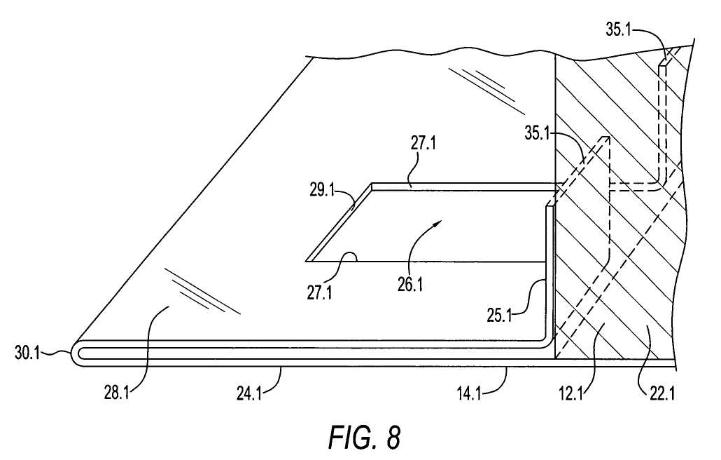

Referring now to FIG. 8 a flange 24.1 is shown according to another embodiment wherein like parts have like reference numerals as the embodiment shown in FIG. 7 with the additional numerical designation “.1”. In the embodiment of FIG. 8, the inter-engagement means is a row of female engagement means 26.1 which are spaced-apart along the longitudinal length of the flange 24.1. For each female engagement means 26.1 the inner plate 28.1 of the flange 24.1 has a pair of opposed transverse edges 27.1 and a longitudinal edges 29.1. The transverse edges 27.1 and the longitudinal edge 29.1 define the recess that forms the female engagement means 26.1.

Referring back to FIG. 3, the channel 23, flanges 24 and inter-engagement means 26 define an inter-engageable marginal portion 21 of the modular building panel 11. The inter-engageable marginal portion 21 of the modular building panel 11 is inter-engageable with a corresponding inter-engageable marginal portion 40 the spline 39. The spline 39 connects pairs of modular building panels to form the modular building panel assembly 10 of FIG. 1.

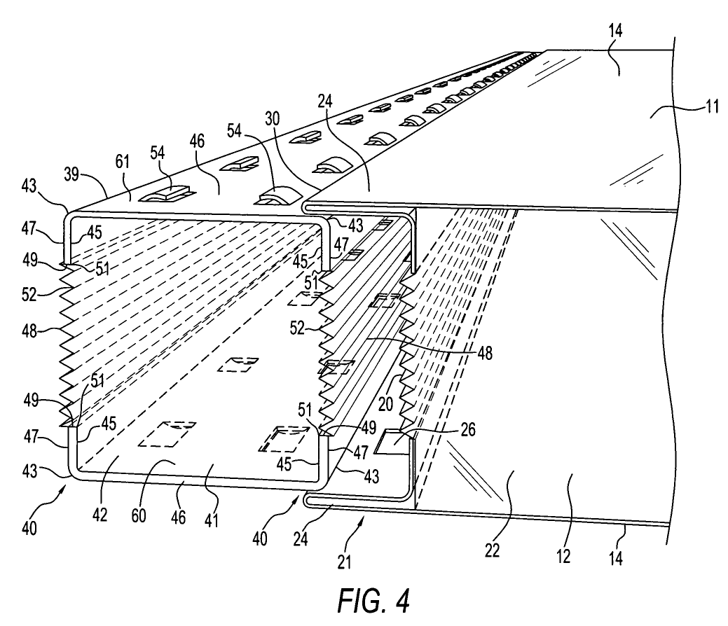

The spline 39 is best shown in FIGS. 2 and 3. In this example, the spline 39 has a thermal insulating core 42 though other materials could be substituted. The thermal insulating core 42 is composed of polystyrene or other suitable core materials. The thermal insulating core 42 has a top end 41, a bottom end (not shown), a pair of opposed side ends 48, and a pair of opposed wall surfaces 50. The terms “top”, “bottom”, and “side” are used in relation to positions when the spline 39 is in an upright orientation as shown in FIG. 2 for the construction of the modular building panel assembly 10 shown in FIG. 1. As best shown in FIG. 4, the side ends 48 may be formed with v-shaped grooves 52. There may also be corresponding v-shaped grooves an opposed surface 20 of the insulating core 12 of the panel 11. This increases friction between the spline 39 and the panel 11 allowing for a tight seal against the penetration of air, vapor, and water.

Referring back to FIG. 3, at least one U-shaped plate 46 is attached to a respective one of the wall surfaces 50 of the insulating core 42 of the spline 39. In this example, the U-shaped plate 46 is made of steel, which provides a strong and rigid surface; however, other suitable materials may also be used. It will further be understood by those skilled in the art that, instead of U-shaped plates, flat plates may be used in alternate embodiments. In this example, the insulating core 42 and the U-shaped plate 46 are attached using glue, however, other suitable means of attachment may be used.

As best shown in FIG. 4 each of the U-shaped plates 46 has at least one rounded corner portion 43 where the U-shaped plate 46 is bent at a right angle to form a flange 47. Each flange 47 has a terminal edge 49. The insulating core 42 of the spline 39 has at least one groove 45 near its corner which corresponds to a respective flange 47. Each groove 45 has a groove end 51. Each flange 47 engages a respective groove 45, with the terminal edge 49 of each said flange 47 abutting the corresponding groove end 51. The grooves 45 further define side end projections 52 of the insulating core 42 of the spline 39. The side end projections 52 extend outwardly beyond the grooves 45.

The spline 39 has inter-engaging means. The side end projections 52 and the inter-engagement means define inter-engageable marginal portions 40 of the spline 39. In this example, the inter-engagement means is a row of spaced-apart male engagement means 54 along the longitudinal length of the spline 39. The male engagement means 54 are resilient projections or leaf springs, and are integral with each of the U-shaped plates 46. The male engagement means 54 extend away from a central longitudinal axis of the spline 39. The rows of the male engagement means 54 on each U-shaped plate 46 are spaced-apart and are separated by a portion of an inner surface 60 of said U-shaped plate 46. Outer surfaces 61 of the U-shaped plates 46 are located between respective rows of the male engagement means 54 and corresponding flanges 47. Although, in this example, there are two rows of male engagement means 54 on each said U-shaped plate 46, it will be understood by those skilled in the art that variations are possible in this regard. For example, in alternative embodiments only one of the U-shaped plates may have male engagement means.

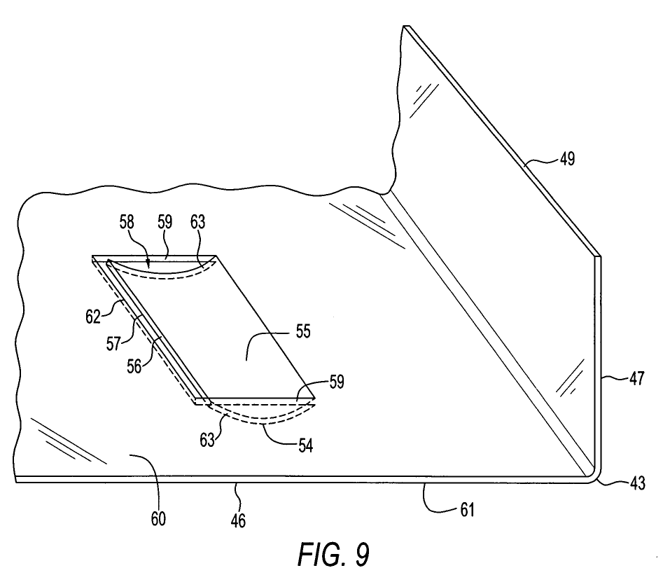

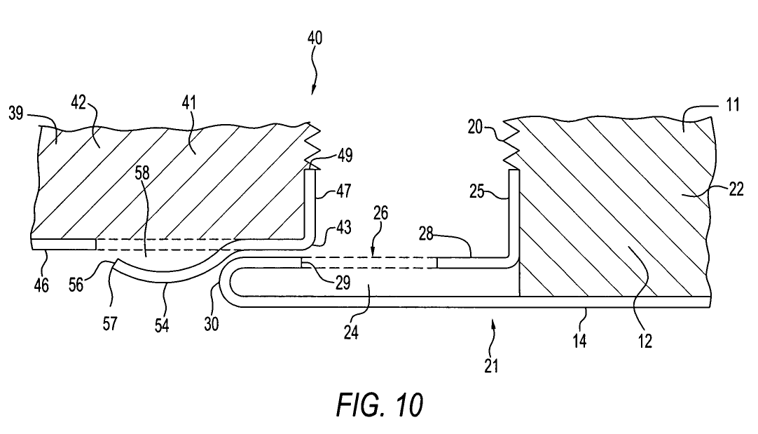

Referring now to FIG. 9, a male engagement means 54 is shown in greater detail. Each male engagement means 54 extends outwardly from the outer portion 61 of the U-shaped plate 46. The male engagement means 54 has a pair of opposite transverse edges 63 and a longitudinal edge 56. The longitudinal edge 56 of the male engagement means 54 has an end corner 57 which is outwardly spaced-apart from the U-shaped plate 46. In this example, the male engagement means 54 is formed by cutting through the plate 46 transversely at reference numerals 59 and longitudinally at reference numeral 62 to form a tab 55 and a recess 58. The tab 55 is then bent to create a curved profile for the male engagement means 54.

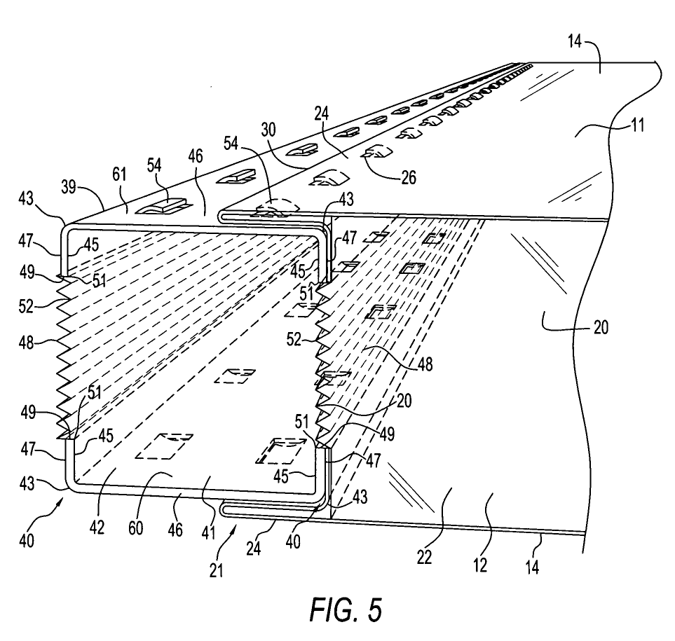

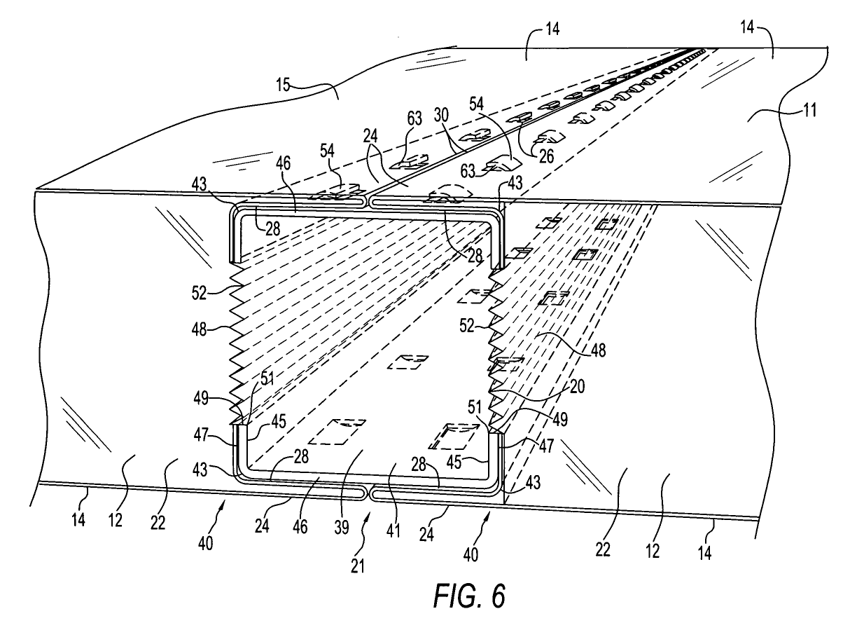

As best shown in FIGS. 4, 5 and 6, the marginal portion 40 of the spline 39 is received by the marginal portion 21 of the modular building panel 11. When the marginal portion 40 of the spline 39 and the marginal portion 21 of the modular building panel 11 are brought together the inter-engaging means of the spline 39 and the inter-engaging means of the modular building panel 11 inter-engage to secure the spline and modular building panel together. As best shown in FIGS. 3 and 6, each marginal portion 40 of the spline 39 may be secured to a respective modular building panel thereby connecting said modular building panels.

As the spline 39 is received within the channel 23 of the modular building panel 11, the male engagement means 54 are deflected towards the U-shaped plates 46 of the spline 39 by the flanges 24 of the modular building panel 11. The male engagement means 54 are deflected towards the U-shaped plates 46 until they become aligned with respective ones of the female engagement means 26, at which point the resilient character of the male engagement means 54 allows them to spring away from the U-shaped plates 46, and into engagement with female engagement means 26.

As best shown in FIG. 6, when the male engagement means 54 and the female engagement means 26 are engaged, portions of the transverse edges 63 of the male engagement means 54 abut portions of respective ones of the transverse edges 27 of the female engagement means 26. This arrangement inhibits movement of the spline 39 relative to modular building panel 11 in the longitudinal direction thereby inhibiting shear between the spline 39 and the modular building panel 11. Furthermore, because each pair of engaged male and female engagement means inhibits shear between the spline 39 and the modular building panel 11, shear is inhibited despite variations occurring during manufacturing which may affect the quality of individual male engagement members or female engagement members; however this can be resolved by providing necessary tolerances to the spacing of the engagement means.

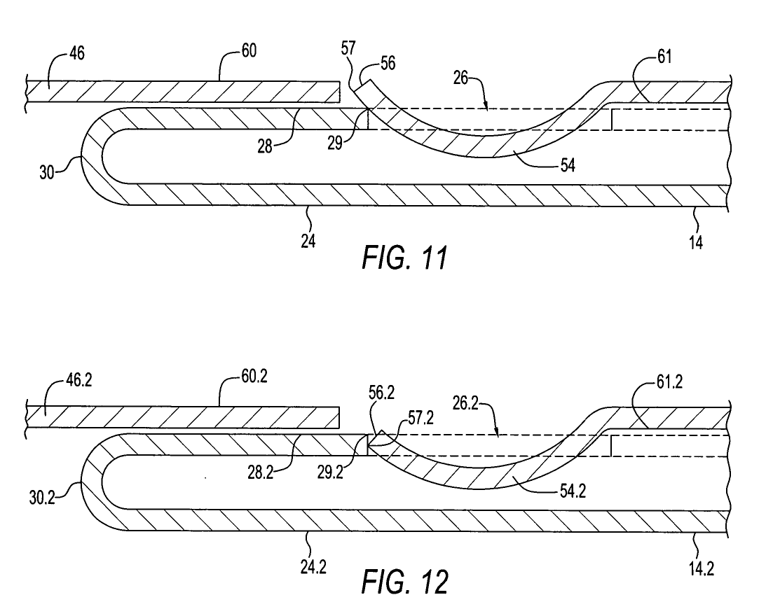

The present invention also allows for either removable or permanent inter-engagement of the modular building panel 11 and the spline 39. As shown in FIG. 11, When the male engagement means 54 and the female engagement means 26 are engaged, if the end corner 57 of the male engagement means 54 extends away from the U-shaped plate 46 but not past the longitudinal edge 29 of the female engagement means 26, the modular building panel 11 and the spline 39 will be removably inter-engaged and can be separated by pulling them apart. This is because when the modular building panel 11 and the spline 39 are pulled apart, the longitudinal edge 29 of the female engagement means 26 will deflect the male engagement means 54 towards the U-shaped plates 46 allowing the male engagement means 54 to be released from the female engagement means 26. The modular building panel 11 and the spline 39 can therefore be pulled apart.

Conversely, and as shown in FIG. 12, when the male engagement means 54.2 and the female engagement means 26.2 are engaged, if the end corner 57.2 of the male engagement means 54.2 extends away from the U-shaped plate 46.2 and into the female engagement means 26.2, the modular building panel 11 and the spline 39 will be permanently inter-engaged. This is because when the modular building panel 11 and the spline 39 are pulled apart the longitudinal edge 56.2 of the male engagement means 54.2 will abut the longitudinal edge 29.2 of the female engagement means 26.2 thereby preventing the release of the male engagement means 54.2 from the female engagement means 26.2. This prevents the modular building panel 11 and the spline 39 from being pulled apart. In FIG. 12, like parts have like reference numerals as in FIG. 11 with the additional numerical designation “.2”.

For one example, it has been shown that if the end corner 57 of the male engagement means is more than 1/16th of an inch away from the U-shaped plate 46 this is a sufficient distance for the end corner 57 to extend into the female engagement member 26, when the male engagement means 54 and the female engagement means 26 are engaged. This allows for a choice to be made as to whether the modular building panel 11 and the spline 39 will be removably or permanently inter-engaged when the male engagement member 54 is formed as described above. Making the end corner 57 of the male engagement member 54 less than 1/16th of an inch away from the U-shaped plate 46 will result in the modular building panel 11 and the spline 39 being removably inter-engaged. Making the end corner 57 of the male engagement member 54 more than 1/16th of an inch away from the U-shaped plate 46 will result in the modular building panel 11 and the spline 39 being permanently inter-engaged. However, in other examples other dimensions for the male engagement means may be used dependent of the material and thickness of the skins.

In this example, the inter-engagement means of the spline 39 are male engagement means 54 and the inter-engagement means of the modular building panel 11 are female engagement means 26. However, in another embodiment, the inter-engagement means of the spline may be female engagement means or a combination of male engagement means and female engagement means. Similarly, the inter-engagement means of the modular building panels may be male engagement means or a combination of male engagement means and female engagement means.

Furthermore, in this example, there are flanges 24 at the marginal portion 21 of the modular building panel 11 forming a channel 23 which receives the marginal portion 40 of the spline 39. However, in another embodiment, there may be flanges at a marginal portion of the spline forming a channel which receives a marginal portion of the modular building panel. Similarly, in yet another embodiment, there may be flanges along a section of a marginal portion of the modular building panel forming a channel which receives a corresponding section of a marginal portion of the spline, and there may be flanges along a section of a marginal portion of the spline forming a channel which receives a corresponding section of a marginal portion of the modular building panel.

As shown in FIGS. 2A and 3A, two of the modular building panels 15 and 17 of the modular building panel assembly 10 of FIG. 1 are inter-engageable with each other. In the example shown in FIGS. 2A and 3A, a first one of the modular building panels 17 has an inter-engageable marginal portion 107 which is similar to the inter-engageable marginal portion 40 of the spline 39 and accordingly is not discussed in detail herein. A second one of the modular building panels 15 has a marginal an inter-engageable marginal portion 105 which is similar to the inter-engageable marginal portion 21 of the standard modular building panel 11 and accordingly is also not discussed in detail herein. In view of the above, it will be understood by a person skilled in the art that the two of the modular building panels 15 and 17 shown in FIGS. 2A and 3A inter-engage in similar manner as described herein for the spline 39 and the standard modular building panel 11.

Also, as shown in FIG. 6A, two of the modular building panels 11 and 19 of the modular building panel assembly 10 of FIG. 1 are inter-engaged by a corner spline 13. The corner spline 13 is generally similar to the spline 39 with the exception that it is L-shaped in cross section and has L-shaped plates 37 and 38. Accordingly, the corner spline is not discussed in greater detail herein. In view of the above, it will be understood by a person skilled in the art that the two of the modular building panels 11 and 19 shown in FIG. 6A inter-engage the spline 13 similar manner as described herein for the spline 39 and the standard modular building panel 11.

It will be understood by those skilled in the art that many of the details provided above are by way of example only and are not intended to limit the scope of the invention which is to be determined with reference to the following claims.

What is claimed is:

1. A modular building panel assembly comprising:
a first member having an inter-engageable marginal portion, the inter-engageable marginal portion of the first member including inter-engagement means and a pair of spaced-apart flanges, the flanges defining a channel; and
a second member having an inter-engageable marginal portion, the inter-engageable marginal portion of the second member including inter-engagement means, and the inter-engageable marginal portion of the second member being receivable between the flanges of the first member;
wherein the inter-engagement means of one of said first member or said second member is a plurality of spaced-apart female engagement means, and the inter-engagement means of another of said first member or said second member is a plurality of resilient, spaced-apart, male engagement means, each said male engagement means being positioned to engage a respective one of said female engagement means when the inter-engageable marginal portion of the second member is received between the flanges, thereby inhibiting shear between the first member and the second member when the modular building panel assembly is constructed.

2. The modular building panel assembly as claimed in claim 1, wherein the first member is a modular building panel and the second member is an inter-panel member.

3. The modular building panel assembly as claimed in claim 2, wherein the inter-panel member is a spline.

4. The modular building panel assembly as claimed in claim 1, wherein the first member is an inter-panel member and the second member is a modular building panel.

5. The modular building panel assembly as claimed in claim 4, wherein the inter-panel member is a spline.

6. The modular building panel assembly as claimed in claim 1, wherein the first member is a modular building panel and the second member is a modular building panel.

7. The modular building panel assembly as claimed in claim 1, wherein at least one of the flanges has the inter-engagement means.

8. The modular building panel assembly as claimed in claim 1, wherein the male engagement means are resilient projections or mechanically controlled projections.

9. The modular building panel assembly as claimed in claim 8, wherein the resilient projections are leaf springs.

10. The modular building panel as claimed in claim 9, wherein each said leaf spring has a first end and a second end, the leaf spring is curved and convex on a side thereof facing the female engagement means, the leaf spring is connected to the one of said first member or said second member at the first end of the leaf spring, the second end of the leaf spring being a free end, the second end of the leaf spring extending away from said another of said first member or said second member when the members are moved towards each other.

11. The modular building panel as claimed in claim 10, wherein the second end of each said leaf spring extends away from the female engagement means so that the members are releasably engaged.

12. The modular building panel as claimed in claim 1, wherein the second end of each said leaf spring engages said another of the said first member or the said second member so the members are permanently engaged.

13. The modular building panel as claimed in claim 1, wherein the female engagement means are recesses.

14. The modular building panel as claimed in claim 1, wherein the female engagement means are openings.

15. The modular building panel assembly as claimed in claim 1, wherein the male engagement means and the female engagement means are releasably engageable.

16. The modular building panel assembly as claimed in claim 1, wherein the male engagement means and the female engagement means are permanently engageable.

17. A method of connecting a first member of a modular building panel assembly to a second member of the modular building panel assembly, the method comprising:
forming a pair of spaced-apart flanges along an inter-engageable marginal portion of the first member, the flanges defining a channel;
forming a plurality of spaced-apart female engagement means along the inter-engageable marginal portion of the first member;
forming a plurality of resilient, spaced-apart, male engagement means along an inter-engageable marginal portion of the second member, the male engagement means being spaced-apart along an axis which is generally perpendicular to a longitudinal axis of the marginal portion of the second member;
positioning the inter-engageable marginal portion of the second member within the channel; and
engaging the male engagement means and female engagement means, thereby inhibiting shear between the first member and the second member.

18. A method of connecting a first member of a modular building panel assembly to a second member of the modular building panel assembly, the method comprising:
forming a pair of spaced-apart flanges along an inter-engageable marginal portion of the first member, the flanges defining a channel;
forming a plurality of resilient, spaced-apart, male engagement means along the inter-engageable marginal portion of the first member, the male engagement means being spaced-apart along an axis which is generally perpendicular to a longitudinal axis of the marginal portion of the first member;
forming a plurality of spaced-apart female engagement means along an inter-engageable marginal portion of the second member;
positioning the inter-engageable marginal portion of the second member within the channel; and
engaging the male engagement means and female engagement means, thereby inhibiting shear between the first member and the second smember.
